(19) United States
(12) Patent Application Publication
(10) Pub. No.: US 2022/0003568 A1
(43) Pub. Date: Jan. 6, 2022

(54) SYSTEM AND METHOD OF FINDING AND ENGAGING WITH HISTORICAL MARKERS

(71) Applicant: James Benge, Dallas, TX (US)

(72) Inventor: James Benge, Dallas, TX (US)

(21) Appl. No.: 17/368,812

(22) Filed: Jul. 6, 2021

Related U.S. Application Data
(60) Provisional application No. 63/048,187, filed on Jul. 5, 2020.

(51) Int. Cl. G01C 21/00; G01C 21/34; G01C 21/36; G01C 21/32; G10L 15/22

(52) U.S. Cl. CPC G01C 21/3811; G01C 21/3476; G01C 21/3608; G10L 2015/221; G01C 21/32; G01C 21/3629; G10L 15/22; G01C 21/362

(57) ABSTRACT

The present invention relates to an application or a system and a method for finding/exploring areas, and specifically historical markers. The application alerts travelers to road-signs that list historical information. In addition to identifying them on a map, user input/output is adapted to accept user-input via spoken user commands, and for playing audio output to the user, the audio output comprising historical marker content and acknowledgement of audio commands. The functionality of the present invention includes a registration process, a data base of markers (i.e., a data), locating and navigating user to the nearest marker (i.e., navigating to a location). The user can add information to the selected marker.

### CLAIM OF PRIORITY, IDENTIFICATION OF RELATED APPLICATIONS

This Provisional patent application claims priority from pending U.S. Patent Application No. 63/048,187 filed on Jul. 5, 2020 entitled HISTORICAL MARKER LOCATING APPLICATION, to common inventor James Benge.

### TECHNICAL FIELD

The present invention generally relates to location aware software applications and historical markers.

### Problem Statement and History

### Interpretation Considerations

This section describes technical field in detail and discusses problems encountered in the technical field. Therefore, statements in the section are not to be construed as prior art.

### Discussion of History of the Problem

One of the joys of leisure and historical travel is the freedom to visit locations and discover gems that are off-the-beaten path. One guidepost to interesting locations are historical markers that dot the landscape in every state in the United States. However, although there are state-managed websites and historical marker identifying applications, there are no platforms that go beyond statically identifying historical markers on a digital map.

Accordingly, there exists the need for an application (App) that empowers users to customize a route to view markers of interest to them, in a manner more user-friendly than static mobile device screen displays.

### TOPICALLY RELATED PUBLICATIONS

Location marker systems and methods are known, such as:

U.S. Pat. No. 6,671,615 discloses a feature provided by a navigation system or other device whereby additional information about roadside signs can be provided to a driver of a vehicle while traveling along a road. The additional information may be provided automatically or in response to a request from the driver. The additional information may include a translation of the sign text into a selected language, supplementary information about the subject matter of the sign, commercial information about the subject matter of the sign, or other kinds of information.

U.S. Pat. No. 7,647,166 discloses a method and system of communicating narrative information to a traveler moving freely through a geographic region. The system can be used in a vehicle or can be carried by hand, for instance while walking or traveling by bicycle. It alerts the traveler to points of interest within a given proximity to the traveler's present location. The traveler can set the proximities within which he or she is alerted to the existence of a point of interest based upon the category into which the point of interest falls, for instance, a museum, a battlefield, a waterfall, a scenic overview, and the like.

US20190145790 discloses a mapping system that provides route guidance in the form of a map and verbal or textual directions which includes reference to both landmarks and personal contacts. Landmarks and contacts can be rated for suitability in providing route guidance. Depending on the rating, guidance using landmarks or personal contacts can be preferentially used in place of or to supplement guidance based on the underlying road network.

### SUMMARY OF THE INVENTION

The present invention relates to a mobile device application for exploring geographic areas having historical markers. The application alerts travelers to road-signs that list historical information. In addition to identifying them on a map, a user can view the text associated with the marker and listen to a reading of that marker.

In an aspect of the present invention, a system for exploring one or more historical markers is disclosed. The system comprises a user interface and a memory. The user interface is configured to display the one or more historical markers present in a user-defined radius as per current location of a user and for allowing the user to select a historical marker from the one or more historical markers present in the user-defined radius. The user interface receives input through one or more voice commands. The user interface is configured to facilitate complete audio input and output control, thereby facilitating safe driving and effective interaction with the system.

The memory comprises a registration unit, a selection unit, a voice command unit, a navigation unit and an output unit. The registration unit enables the user to register in the system. The selection unit is configured for setting the user-defined radius as per the current location of the user to further identify the one or more historical markers in the user-defined radius. The voice command unit is associated with the user interface that processes the one or more voice commands as an audio input and to provide output control. The navigation unit is configured to navigate to the selected historical marker and the output unit is configured to read description text of the selected historical marker.

According to various embodiments of the present invention, the system further comprises a means for enabling the user to suggest that a new historical marker be located at a suggested coordinate and associated with a specific thing or event.

According to various embodiments of the present invention, the system further comprises a recording unit that is configured to record audio and/or video in association with the one or more historical markers; a notification unit that notifies the user about the one or more historical markers while navigating to a location; and a posting unit through which the user can post image(s), text and/or audio with respect to a chosen historical marker.

In another aspect of the present invention, a method for exploring one or more historical markers is disclosed. The method comprises acts of registering a user in a system through a registration unit, setting a user-defined radius by a selection unit as per current location of the user to further identify the one or more historical markers in the user-defined radius, displaying, by a user interface, the one or more historical markers present in the user-defined radius as per the current location of the user and allowing the user to select a historical marker from the one or more historical markers present in the user-defined radius, navigating the user to the selected historical marker through a navigation unit, and reading description text of the selected historical marker by an output unit. The method enables the user to suggest that a new historical marker be located at a suggested coordinate and associated with a specific thing or event. The method processes the one or more voice commands as an audio input and providing an output control by a voice command unit associated with the user interface.

The method further comprises recording audio and/or video in association with the one or more historical markers by a recording unit, notifying the user about the one or more historical markers while navigating to a location by a notification unit and posting information, by a posting unit, with respect to a chosen historical marker, wherein the information corresponds to image, text and/or audio.

### BRIEF DESCRIPTION OF THE DRAWINGS

Various aspects of the invention and its embodiment are better understood by referring to the following detailed description. To understand the invention, the detailed description should be read in conjunction with the drawings.

FIG. 1 illustrates a system to locate one or more historical markers.

FIG. 2 shows a user interface for logging in and/or signup by a user in the system.

FIG. 3 depicts the user interface displaying territorial/geographical areas that may be selected by the user.

FIG. 4 shows the user interface having the one or more historical markers in a user defined radius/vicinity.

FIG. 5 is a list view displaying nearby historical markers in a selected territorial/geographical area.

FIG. 6 is a flowchart illustrating a method to locate the one or more historical markers.

FIG. 7 is a flowchart depicting working of the system that locates the one or more historical markers.

FIG. 8 represents a menu option of the system illustrated in FIG. 7.

### DESCRIPTION OF AN EXEMPLARY PREFERRED EMBODIMENT

### Interpretation Considerations

While reading this section (Description of An Exemplary Preferred Embodiment, which describes the exemplary embodiment of the best mode of the invention, hereinafter referred to as “exemplary embodiment”), one should consider the exemplary embodiment as the best mode for practicing the invention during filing of the patent in accordance with the inventor's belief. As a person with ordinary skills in the art may recognize substantially equivalent structures or substantially equivalent acts to achieve the same results in the same manner, or in a dissimilar manner, the exemplary embodiment should not be interpreted as limiting the invention to one embodiment.

The discussion of a species (or a specific item) invokes the genus (the class of items) to which the species belongs as well as related species in this genus. Similarly, the recitation of a genus invokes the species known in the art. Furthermore, as technology develops, numerous additional alternatives to achieve an aspect of the invention may arise. Such advances are incorporated within their respective genus and should be recognized as being functionally equivalent or structurally equivalent to the aspect shown or described.

A function or an act should be interpreted as incorporating all modes of performing the function or act, unless otherwise explicitly stated. For instance, sheet drying may be performed through dry or wet heat application, or by using microwaves. Therefore, the use of the word “paper drying” invokes “dry heating” or “wet heating” and all other modes of this word and similar words such as “pressure heating”.

Unless explicitly stated otherwise, conjunctive words (such as “or”, “and”, “including”, or “comprising”) should be interpreted in the inclusive and not the exclusive sense.

As will be understood by those of the ordinary skill in the art, various structures and devices are depicted in the block diagram to not obscure the invention. In the following discussion, acts with similar names are performed in similar manners, unless otherwise stated.

The foregoing discussions and definitions are provided for clarification purposes and are not limiting. Words and phrases are to be accorded their ordinary, plain meaning, unless indicated otherwise.

### DESCRIPTION OF THE DRAWINGS, A PREFERRED EMBODIMENT

The present invention relates to an application or a platform or a system for finding/exploring areas, and specifically historical markers and a method for finding/exploring areas. The application alerts travelers to road-signs that list historical information. In addition to identifying them on a map, a user can view the text associated with the historical marker and listen to a reading of that historical marker. The functionality of the invention includes a registration process, a data base of markers (i.e. a data), locating and navigating user to the nearest marker (i.e., navigating to a location). The user can also add information about the marker to the data about a historical marker.

Advantageously, with the use of the present invention, users enjoy discovering gems such as historical markers that are off-the-beaten path. An option to set user preferences makes the present invention more user centric and user friendly. Additionally, in one embodiment the present invention provides completely voice-controlled/hands-free experience to the users who are visiting the historical markers and hence, provides efficient and smooth navigation from a current place to nearby historical marker in the user's defined radius/vicinity. Furthermore, features to add, record and/or post information to the data about the selected historical marker in the form of text or voice or image (for others to view/listen to) enhances the user-experience of the person adding the information, as well as the experience of future users who ‘visit’ that historical marker (hereinafter, the terms ‘marker’ and ‘historical marker’ may interchangeably be used throughout the present invention).

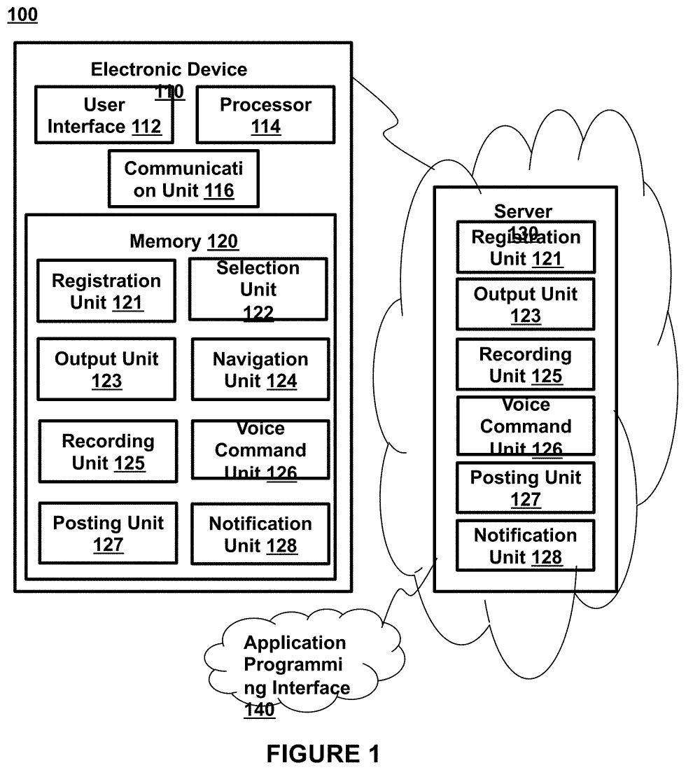

FIG. 1 illustrates a system 100 to locate and/or explore one or more historical markers. The system 100 comprises an electronic device 110, a server 130 and one or more application programming interfaces 140.

The electronic device 110 includes a user interface 112, a processor 114, a communication unit 116 and a memory 120. The electronic device 110 may be a user device such as, but not limited to a phone, a laptop, a pager, a tablet computer. Preferably, the electronic device 110 is a smartphone.

The user interface 112 allows interaction of the user with the system 100. The user interface 112 displays the one or more historical markers present in a user-defined radius as per current location of the user and allows the user to select a historical marker from the one or more historical markers present in the user-defined radius. The user interface 112 comprises suitable logic, circuitry, interfaces, and/or code that may be configured to provide one or more inputs to the system 100 and its components. The user interface 112 may be a screen or a display such as an LCD (liquid-crystal display), an LED (Light emitting diode display), for example. Additionally, the user interface 112 may use or may be associated with a keyboard, a mouse, a joystick, a touch screen, a microphone, a camera, a docking station and/or a speaker. In an implementation, the user interface 112 receives input through one or more voice commands. Alternatively, the user interface 112 receives input through clicks and taps.

Advantageously, the user interface 112 facilitates complete audio input and output control for the system 100, thereby facilitating safe driving and effective interaction with the system.

The processor 114 is configured to execute instructions stored in the memory 120 and to perform various processes based on several processor technologies known in the art. Examples of the processor 114 include, but not limited to, an X86-based processor, a Reduced Instruction Set Computing (RISC) processor, an Application-Specific Integrated Circuit (ASIC) processor, and a Complex Instruction Set Computing (CISC).

The communication unit 116 is configured for communicating internally between internal hardware components and with external devices via one or more networks. The communication unit 116 may include transceiver that allows connecting with the server 130. The communication unit 116 may implement one or more known technologies to support wired or wireless communication. The communication unit 116 may include, but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. Also, the communication unit 116 may communicate via wireless communication with networks, such as the Internet, an Intranet and/or a wireless network, such as a cellular telephone network, a wireless local area network (LAN) and/or a metropolitan area network (MAN).

Accordingly, the wireless communication may use any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The memory 120 includes suitable logic, circuitry, interfaces, and/or code that may be configured to store the set of instructions, which are executed by the processor 114. Preferably, the memory 120 is configured to store one or more programs, routines, or scripts that are executed in coordination with the processor 114. Additionally, the memory 120 may be implemented based on a Random Access Memory (RAM), a Read-Only Memory (ROM), a Hard Disk Drive (HDD), a storage server, and/or a Secure Digital (SD) card. In an embodiment of the present invention, the memory 120 comprises a registration unit 121, a selection unit 122, an output unit 123, a navigation unit 124, a recording unit 125, a voice command unit 126, a posting unit 127 and a notification unit 128.

The registration unit 121 is configured to register the user with the system, specifically with the application (app). The user fills in requisite information, for example, contact number, name, age etc., to register himself in the app to further access the one or more historical marker.

The selection unit 122 provides a feature to select or set a radius/range/vicinity based on the current location of the user. After setting the radius, the one or more historical markers can be viewed therein, which can be selected by the user as a destination.

The output unit 123 is configured to read description text of the selected historical marker. The output unit 123 may be a software plugin, a hardware such as speaker, for example.

The navigation unit 124 is configured to provide navigation to the selected historical marker. The navigation unit 124 determines the current location of the user and provides a mapped path for navigation to the selected historical marker. The navigation unit 124 may determine the current location of the user using triangulation techniques based on Wi-Fi signals and/or cellular tower signals or any other technology known in the art. The navigation unit 124 may include a GPS (Global Positioning Satellite) receiver or a compass, or an accelerometer, for example.

The recording unit 125 is configured to record audio and/or video in association with the one or more historical markers. Through the recording unit 125, the user can add to or record audio or video, associated with a historical marker in the form of text or voice or image (for others to view/listen to). This allows for interesting readings. For example, if the historical marker is about a children's school, then a child or children may read information about the historical marker and the place and/or event(s) it commemorates. As an additional example, a living person associated with a historical marker location, a descendent, or interested famous person may record audio/video related to the marker. Further, a person associated with the user of the App, such as a relative, friend, or tour guide may record audio/video related to the historical marker.

The voice command unit 126 may be associated with the user interface 112 to process the one or more voice commands as an audio input and to provide output control, as the system 100 is a voice-controlled/operated system.

The posting unit 127 allows the user to post information such as image, text and/or audio with respect to a chosen historical marker. In an embodiment of the present invention, the posting unit 127 and the recording unit 125 may form a single unit to perform recording and posting functions.

The notification unit 128 notifies the user about the one or more historical markers while navigating to a location. For example, if a user is traveling from location A to location B, in that case, the notification unit 128 sends alerts and notification about the one or more historical markers present between the location A and the location B.

The memory 120 is coupled with the server 130. The server 130 includes the registration unit 121, the output unit 123, the recording unit 125, the voice command unit 126, the posting unit 127 and the notification unit 128. The functional units of the server 130 performs the same operation as the functional units of the memory, which is already explained above.

The server 130 may be a cloud application server that may include a database (not shown but understood by those of ordinary skill in the cloud internet arts). The database server may refer to a computing device that may be configured to store one or more trained machine learning models, training data, for example. Additionally, the server 130 may communicate with the database using one or more protocols such as, but not limited to, Open Database Connectivity (ODBC) protocol and Java Database Connectivity (JDBC) protocol to fetch and collect information related to the user, the one or more historical markers, routes, for example. The database may include a special purpose operating system specifically configured to perform one or more database operations. Examples of database operations may include, but are not limited to, Select, Insert, Update, Push, Pull, and Delete. Additionally, the database server may include hardware that is configured to perform one or more predetermined operations. Accordingly, the database server may be realized through various technologies such as, but not limited to, Microsoft® SQL Server, Oracle®, IBM DB2®, Microsoft Access®, PostgreSQL®, MySQL® and SQLite®, for example.

The one or more application programming interfaces (APIs) 140 are any third-party APIs such as Google APIs such as email API for registration/signup/login to the App, map API for navigation/location determination etc., Facebook APIs, for example to allow registration, to provide navigation or other functional features known in the art.

The system 100 further includes a means that enables the user to suggest that a new historical marker be located at a suggested coordinate (latitude-longitude) and associated with a specific thing or event.

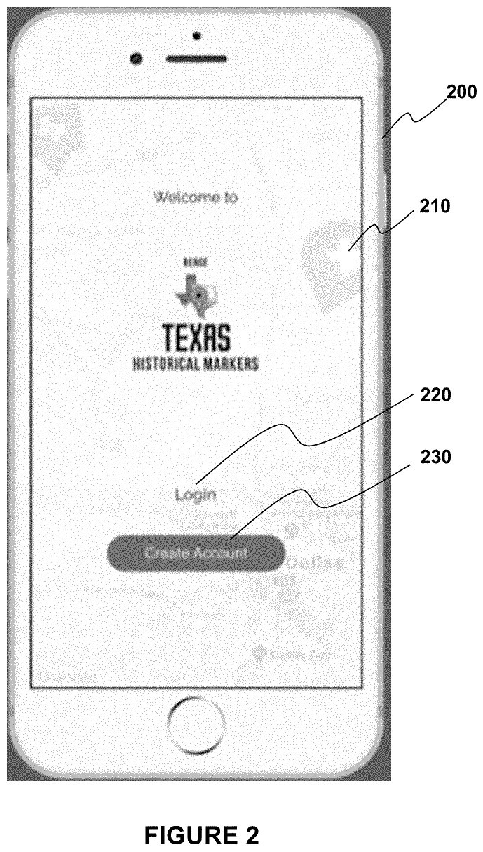

FIG. 2 shows a user interface 210 of an electronic/mobile device 200 for logging in and/or signup in the system (or App). The user interface 210 is same as the user interface 112. The user interface 210 depicts a login button 220 and a create account button 230. The login button 220 allows the user to login to the system 100. Similarly, the create account button 230 enables the user to sign up/register in the App.

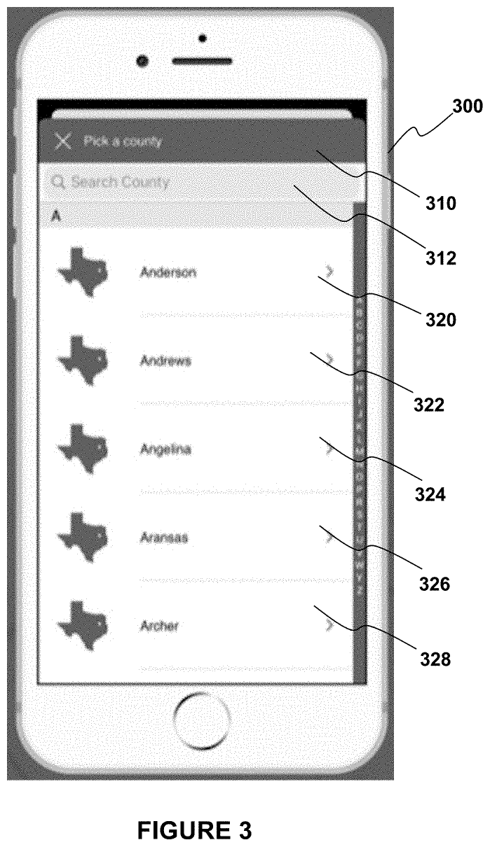

FIG. 3 depicts a user interface 310 of an electronic/mobile device 300. The user interface 310 displays territorial/geographical areas such as a county 320, 322, 324, 326, 328 that may be selected by the user. A search bar 312 allows the user to search a name of a county of his interest to which the user wishes to travel from his current location. Each of the listed county 320, 322, 324, 326, 328 is further explored by clicking/tapping on it or through the one or more voice commands.

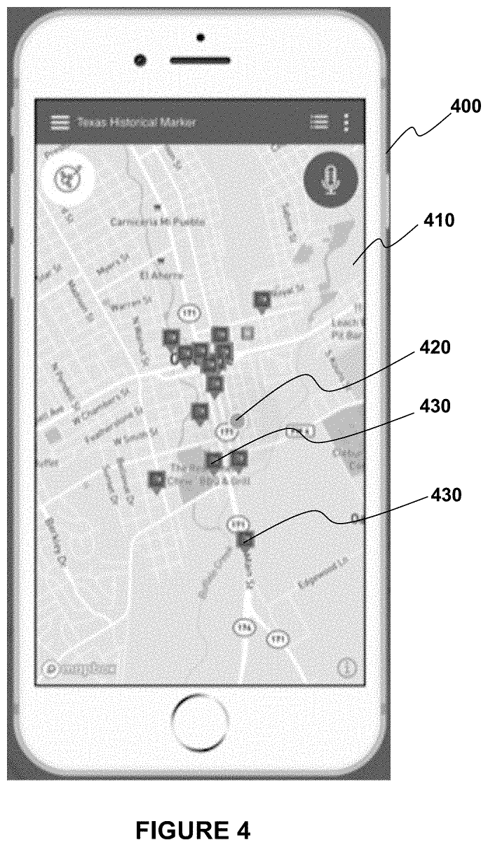

FIG. 4 shows a user interface 410 of an electronic/mobile device 400 having the one or more historical markers 430 in a user defined radius/vicinity of a selected territorial/geographical area. The current location of the user is depicted by reference numeral 420. The user may choose any of the one or more historical markers 430 by tapping on it. After tapping on a historical marker, the navigation unit 124 provides direction on the map.

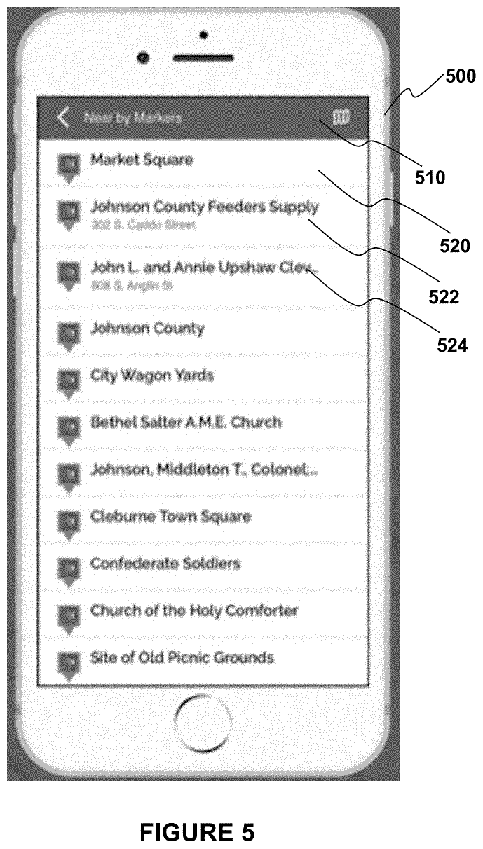

FIG. 5 is a list view displaying nearby historical markers in a selected territorial/geographical area on a user interface 510 of an electronic/mobile device 500. The nearby markers are listed as 520, 522, 524 and so on so forth.

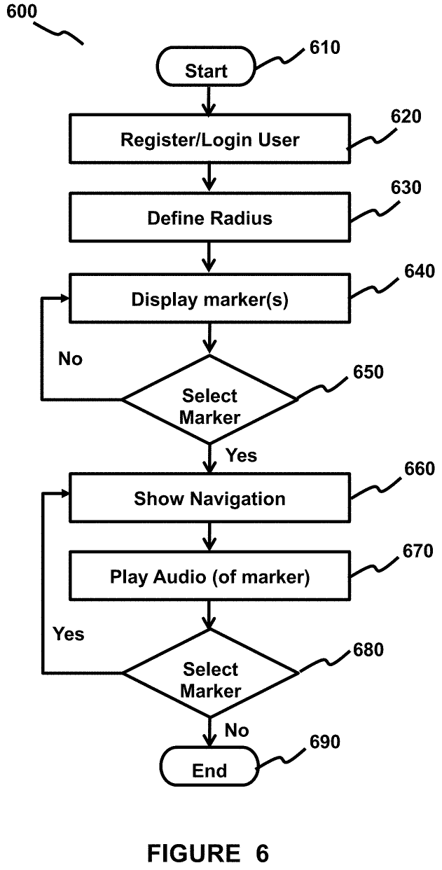

FIG. 6 is a flowchart 600 illustrating a method to locate the one or more historical markers. The method is performed by the system 100. FIG. 6 may be read in conjunction with FIG. 1 through FIG. 5 and FIG. 7.

The method starts at an act 610. In an act 620, the user registers himself in the App. If the user is already registered, in such a case, the user can directly login to the App.

The act of register/login user is followed by an act of define radius 630. The user can set or define his preferences such as a radius in which he wishes to look for/visit the one or more historical markers.

The act of define radius 630 is followed by an act of display marker(s) 640. In this act, based on the user defined radius, the app displays the one or more historical markers.

The act of display marker(s) 640 is followed by an act of select marker 650. This act i.e., 650 works as a decision phase for the app, where the user can choose/select a historical marker and get navigation for the same at an act 660 or the user can reset his preferences to receive another set of the one or more historical markers.

If the act of show navigation, i.e., the act 660 is selected, then at the next act 670, the app plays audio of the selected historical marker. The audio, preferably, is a reading of the selected historical marker.

Upon finishing of the audio reading, the user gets an option to select another marker at 680. If the user wishes to select another marker, then the act show navigation 660 and the act play audio 670 will be repeated. Else, the method will be terminated at 690.

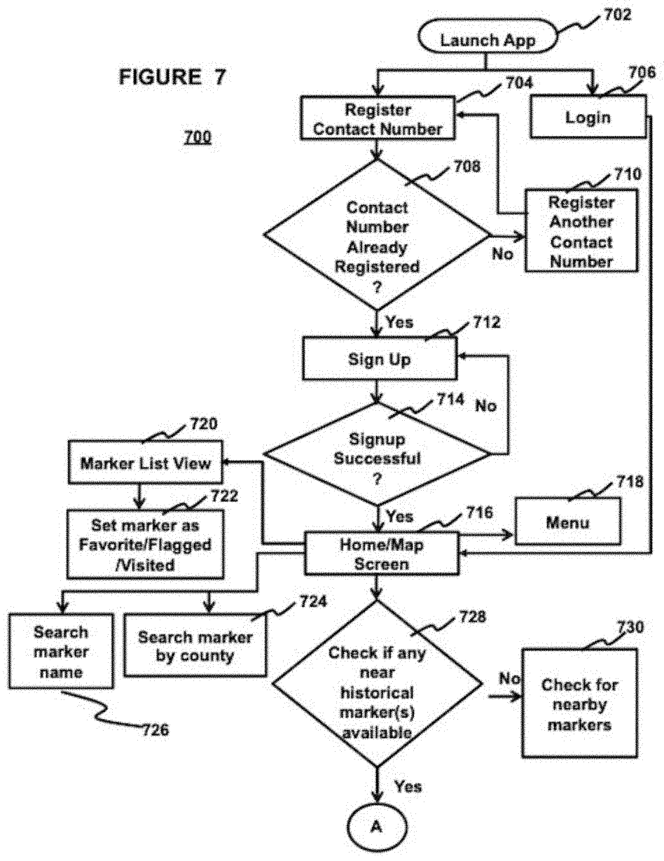

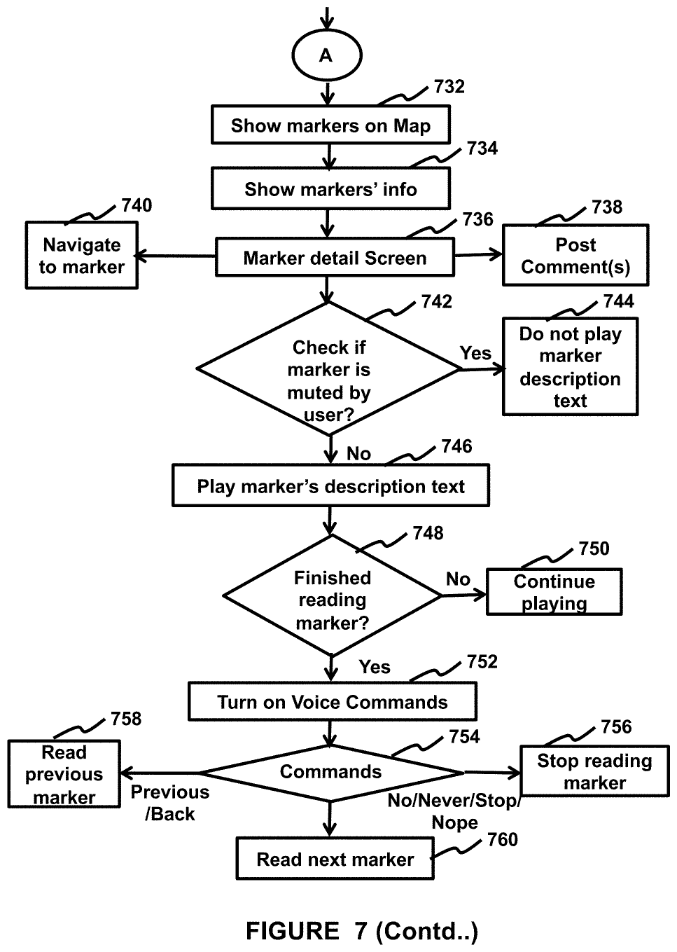

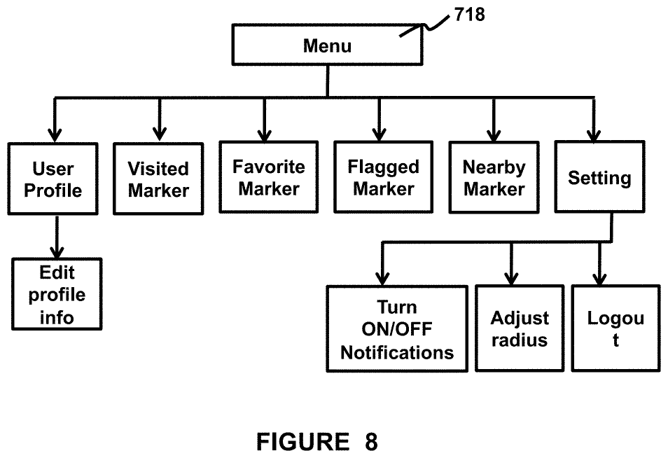

FIG. 7 is a flowchart depicting working of the system that locates the one or more historical markers. FIG. 8 represents a menu option of the system illustrated in FIG. 7. FIG. 7 and FIG. 8 may be read in conjunction with FIG. 1 through FIG. 6.

The system (or App) 100 comes with various functionalities such as the user interacts with the App to provide (visually or auditorily) historical markers along a chosen route, or within a proximity of that route. In addition, the App provides historical marker information within a certain distance in radius, or along an arc in the direction of user travel or indicated travel route/direction. Additional functionality is achieved by presenting historical markers to the user based on their stated preferences, or preferences inferred based on prior visits and/or visited markers and/or inferred interactions with similar markers (such as time at a location) and co-associates amenities such as restrooms and picnic tables with user preferences. Voice-control application preferably achieves a completely hands-free user experience.

In other words, a user is preferably able to open and choose any historical-marker related feature in the App with voice commands, and the App is preferably able to verify the command, indicate the next step to be taken, and to provide guidance to the user via audio feedback in a variety of voices based on user selections and preferences. Additional features provide for interacting with state agencies that place and maintain the historical markers, such as identification of markers that need repair, and also the identification on interesting locations that do not have historical markers but in the opinion of the user should have historical markers associated with it/them. Additional features and functionality are readily to those of skill in the App arts upon review of the accompanying drawings.

To explain the aforesaid information, referring to FIG. 7. Once the system is launched at 702, the system 100 pops up with two options, where the user can register his contact number at 704 or directly login at 706 if already registered.

During the registration process, the system checks at 708 whether the contact number already registered. If yes, then the user is prompted to sign up screen at 712, else, the user is asked to register another contact number at 710.

For sign up process, the user fills in required details, such as name, age, address, for example. If the sign up is successful at 714, then the user is provided with a home/map screen at 716, else the sign-up process will be reinitiated. Further, if the user is already registered, then the user is landed with the home/map screen directly.

The home/map screen comes with various options to select. For example, the user can access menu at 718 (explained and shown in FIG. 8) from the home/map screen or the user can select marker (or historical marker) list view at 720 or the user can search marker by county at 724 or the user can search marker by name at 726.

If the user selects the marker list view, then the app will display an option to set the marker as Favorite/Flagged/Visited at 722.

When the user is at the home/map screen, the system checks at 728 if any near historical marker(s) available as per the current location of the user and selected radius by the user. If no, then the system checks for nearby historical markers at 730, when the user's location is changed. If yes, then the system shows markers on the map at 732 and marker's information at 734. From the marker's information page, the user will be redirected to a marker detail screen at 736. At the marker detail screen, the user gets two options such as post comment(s) at 738 and navigate to the marker at 740. If the user choses to navigate to the marker (historical marker), then the user will be navigated to that historical marker from his current location. The user can post comment(s) in the form of image(s), text, audio.

At the marker detail screen, the system checks if the marker is muted by user at 742. If yes, the system does not play the description text of the marker as shown at 744. If no, the system plays the description text of the marker at 746.

The system further checks, at 748, if the marker reading is finished. If no, then the system choses to continue playing the description text at 750. If the marker reading is finished, then voice commands can be activated at 752 to relay the one or more voice commands to the system for further processing. For example, a command to stop reading the marker may be No/Never/Stop/Nope as shown at 754 and 756. Similarly, a command to read previous marker may be previous/back as shown at 754 and 758. Further, a command may be provided to read next marker at 760.

Referring to FIG. 8, the menu shown at 718 includes a plurality of options such as user profile, visited marker, favorite marker, flagged marker, nearby marker, setting, for example.

The user profile has the information of the user provided at the time of registration/sign up process. The user can also edit his profile information. The visited marker comprises a list of historical markers visited by the user. The favorite marker comprises a list of historical markers marked favorite by the user. The flagged marker comprises a list of historical markers marked flagged by the user. The nearby marker comprises a list of historical markers located near to the current location of the user. Lastly, the setting option may include, but not limited to, turn ON/OFF notifications, adjust radius and logout. The user may turn ON the notifications if he wishes to receive so, else may turn OFF. The adjust radius option allows the user to select/set a radius in which he is exploring the one or more historical markers.

Although the invention has been described and illustrated with specific illustrative embodiments, it is not intended that the invention be limited to those illustrative embodiments. Those skilled in the art will recognize that variations and modifications can be made without departing from the spirit of the invention. Therefore, it is intended to include within the invention, all such variations and departures that fall within the scope of the appended claims and equivalents thereof.

What is claimed is:

1. A system for exploring one or more historical markers, comprising:
a user interface for displaying the one or more historical markers present in a user-defined radius as per current location of a user and for allowing the user to select a historical marker from the one or more historical markers present in the user-defined radius;
a memory, the memory comprising:
a registration unit for enabling the user to register in the system;
a selection unit for setting the user-defined radius as per the current location of the user to further identify the one or more historical markers in the user-defined radius;
a navigation unit configured to navigate to the selected historical marker; and
an output unit configured to read description text of the selected historical marker.

2. The system of claim 1 further comprising a means for enabling the user to suggest that a new historical marker be located at a suggested coordinate.

3. The system of claim 1 wherein the user interface receives input through one or more voice commands.

4. The system of claim 1 wherein the user interface receives input through clicks and taps.

5. The system of claim 1 further comprising a voice command unit associated with the user interface to process the one or more voice commands as an audio input and to provide output control.

6. The system of claim 1 wherein the user input/output is adapted to accept user-input via spoken user commands, and for playing audio output to the user, the audio output comprising historical marker content and acknowledgement of audio commands.

7. The system of claim 1 further comprising:
a recording unit configured to record audio and/or video in association with the one or more historical markers;
a notification unit to notify the user about the one or more historical markers while navigating to a location; and
a posting unit to allow the user to post image, text and/or audio with respect to a chosen historical marker.

8. A system for exploring one or more historical markers, comprising:
a user interface for displaying the one or more historical markers present in a user-defined radius as per current location of a user and for allowing the user to select a historical marker from the one or more historical markers present in the user-defined radius, wherein the user interface receives input through one or more voice commands;
a memory, the memory comprising:
a registration unit for enabling the user to register in the system;
a selection unit for setting the user-defined radius as per the current location of the user to further identify the one or more historical markers in the user-defined radius;
a voice command unit associated with the user interface to process the one or more voice commands as an audio input and to provide output control;
a navigation unit configured to navigate to the selected historical marker; and
an output unit configured to read description text of the selected historical marker.

9. The system of claim 8 further comprising a means for enabling the user to suggest that a new historical marker be located at a suggested coordinate.

10. The system of claim 8 wherein the user input/output is adapted to accept user-input via spoken user commands, and for playing audio output to the user, the audio output comprising historical marker content and acknowledgement of audio commands.

11. The system of claim 8 further comprising:
a recording unit configured to record audio and/or video in association with the one or more historical markers;
a notification unit to notify the user about the one or more historical markers while navigating to a location; and
a posting unit to allow the user to post image, text and/or audio with respect to a chosen historical marker.

12. A method for exploring one or more historical markers, comprising:
registering, through a registration unit, a user in a system;
setting, by a selection unit, a user-defined radius as per current location of the user to further identify the one or more historical markers in the user-defined radius;
displaying, by a user interface, the one or more historical markers present in the user-defined radius as per the current location of the user and allowing the user to select a historical marker from the one or more historical markers present in the user-defined radius;
navigating, by a navigation unit, the user to the selected historical marker; and
reading, by an output unit, description text of the selected historical marker.

13. The method of claim 12 further comprising enabling, by a means, the user to suggest that a new historical marker be located at a suggested coordinate.

14. The method of claim 12 wherein user input/output is adapted to accept user-input via spoken user commands, and for playing audio output to the user, the audio output comprising historical marker content and acknowledgement of audio commands.

15. The method of claim 12 wherein the user interface receives input through clicks and taps.

16. The method of claim 12 further comprising: processing, by a voice command unit associated with the user interface, the one or more voice commands as an audio input and providing an output control.

17. The method of claim 12 wherein the user interface is configured to facilitate complete audio input and output control, thereby facilitating safe driving and effective interaction with the system.

18. The method of claim 12 further comprising: recording, by a recording unit, audio and/or video in association with the one or more historical markers.

19. The method of claim 12 further comprising: notifying, by a notification unit, the user about the one or more historical markers while navigating to a location.

20. The method of claim 12 further comprising posting information, by a posting unit, with respect to a chosen historical marker, wherein the information corresponds to image, text and/or audio.
